(19) United States
(12) Patent Application Publication
(10) Pub. No.: US 2013/0341057 A1
(43) Pub. Date: Dec. 26, 2013

(54) FASTENER-DRIVING TOOL WITH AN ELECTRIC POWER GENERATOR

(71) Applicant: ILLINOIS TOOL WORKS INC., Glenview, IL (US)

(72) Inventor: Stephen P. Moore, Palatine, IL (US)

(73) Assignee: ILLINOIS TOOL WORKS INC., Glenview, IL (US)

(21) Appl. No.: 13/796,255

(22) Filed: Mar. 12, 2013

Related U.S. Application Data
(60) Provisional application No. 61/662,737, filed on Jun. 21, 2012.

(51) Int. Cl. B25C 7/00

(52) U.S. Cl. CPC B25C 7/00
USPC 173/20

(57) ABSTRACT

A fastener driving tool is provided including a housing, a cylinder enclosed by the housing and at least one sensor associated with the cylinder. A piston is configured to reciprocate within the cylinder and has a driver blade depending therefrom. At least one signal generator is associated with the piston, where movement of the piston relative to the at least one sensor generates a signal.

### RELATED APPLICATION

This application claims 35 USC 119(e) priority from U.S. Provisional Application Ser. No. 61/662,737 filed Jun. 21, 2012

### BACKGROUND

The present invention relates generally to fastener-driving tools, and particularly to such tools being powered electrically, by compressed gas, combustion or powder.

Powered fastener-driving tools, and particularly those using compressed air as an energy source, incorporate a housing enclosing a cylinder. Slidably mounted within the cylinder is a piston assembly in communication on one side with a supply chamber and a return chamber on the opposite side thereof. The piston assembly includes a piston head and a rigid driver blade that is disposed within the cylinder. A movable valve plunger is oriented above the piston head. In its at-rest position this valve plunger prevents the drive chamber from communicating to the piston assembly and allows an air flow path to atmosphere above the piston assembly. In its actuated state, the valve plunger prevents or blocks the air flow path to atmosphere and allows an air flow path to the drive chamber

When a tool's actuation requirements have been met, the movable valve plunger opens and exposes one side of the piston assembly to a compressed gas energy source. The resulting pressure differential causes the piston and driver blade to be actuated downward to impact a positioned fastener and drive it into a workpiece. Fasteners are fed into the nosepiece from a supply assembly, such as a magazine, where they are held in a properly positioned orientation for receiving the impact of the driver blade.

As the piston is actuated downward, it drives the air inside the cylinder through a series of vents into the return chamber increasing the pressure in this chamber. After the fastening event has taken place, the valve plunger moves back to the at-rest position, blocking the supply chamber's air flow path to the piston head and releasing the pressure above the piston head through the path to atmosphere. At this time, the pressure built in the return chamber pushes the piston assembly back up towards the top of the cylinder. The air above the piston head is forced through the valve plunger's air flow path to atmosphere.

Other fastener-driving tools operate similarly in that a reciprocating driver blade drives fasteners fed to a nosepiece by a biased magazine. The power source varies, with combustion, electric and powder operated tools being well known in the art.

Several of the controls and indicators for fastener-driving tools are powered by internal electrical circuitry and power sources such as batteries. The operation of the fastener-driving tools and thereby the controls and indicators in these tools, depletes the power stored in the internal power sources.

### SUMMARY

The foregoing and other objectives are achieved in accordance with the teachings and principles of the present invention through the provision of a fastener-driving tool having an electrical generator for generating electricity to power different components of the tool.

In an embodiment, a fastener-driving tool is provided and includes a housing, a cylinder enclosed by the housing and at least one sensor associated with the cylinder. A piston is configured to reciprocate within the cylinder and has a driver blade depending therefrom. At least one signal generator is associated with the piston, where movement of the piston relative to the at least one sensor generates a signal.

In another embodiment, a fastener-driving tool is provided and includes a housing, a cylinder enclosed by the housing, a plurality of sensors associated with the cylinder and a piston configured to reciprocate within the cylinder and having a driver blade depending therefrom. At least one signal generator is associated with the piston, where movement of the piston relative to each of the plurality of sensors generates electricity. A storage device is configured to receive and store the electricity.

### BRIEF DESCRIPTION OF THE DRAWINGS

FIG. 1 is a side perspective view of a pneumatic fastening tool in accordance with one example embodiment of the present invention;

FIG. 2 is a fragmentary side vertical section of the pneumatic fastening tool of FIG. 1;

FIG. 3 is a fragmentary perspective view of a piston assembly in the pneumatic fastening tool of FIG. 1;

FIG. 4 is an elevation view of the piston assembly of FIG. 3;

FIG. 5 is a perspective view of an embodiment of the piston in the piston assembly of FIG. 3;

FIG. 6 is a perspective view of another embodiment of the piston in the piston assembly of FIG. 3;

FIG. 7 is a vertical section of the piston assembly of FIG. 3 showing the piston at the top of the cylinder; and

FIG. 8 is a vertical section of the piston assembly of FIG. 3 showing the piston at the bottom of the cylinder; and

FIG. 9 is a fragmentary perspective view of another embodiment of the piston assembly in the pneumatic fastening tool of FIG. 1.

### DETAILED DESCRIPTION

The present invention relates generally to powered, fastener-driving tools, wherein the tools may be electrically powered, pneumatically powered, combustion powered, or powder activated, and more particularly to a powered fastener-driving tool including an electrical generator configured to generate electricity to be used by other components of the tool and/or stored in a storage device or a plurality of storage devices, such as one or more internal or rechargeable batteries for use during operation of the tool.

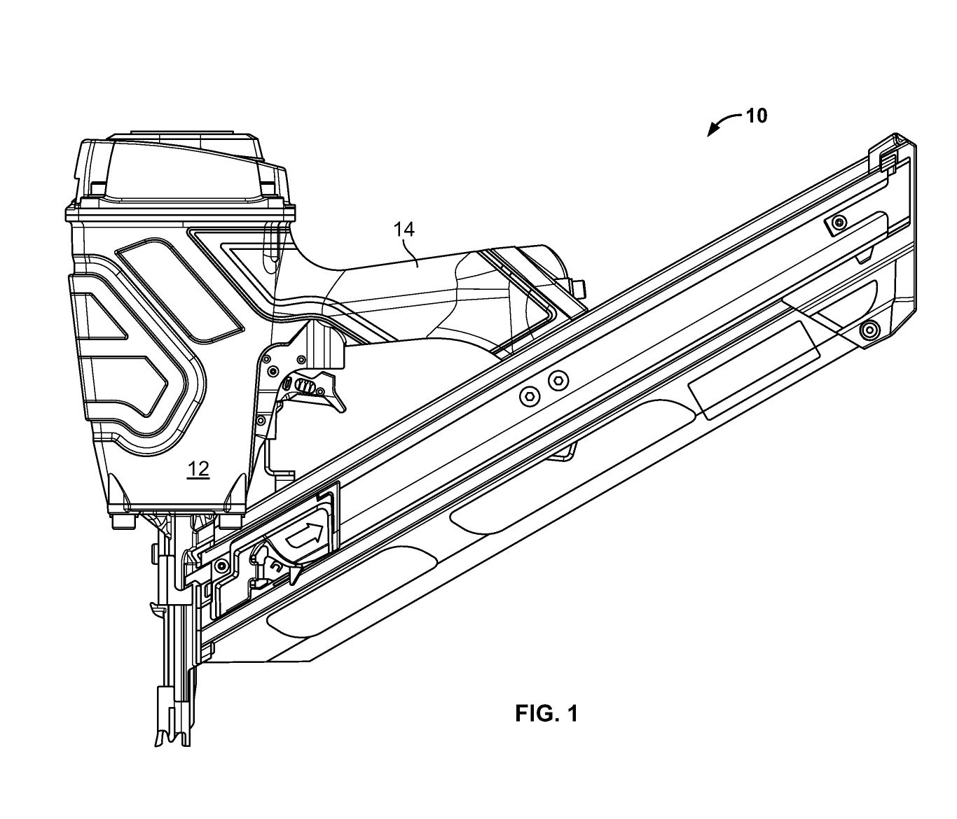

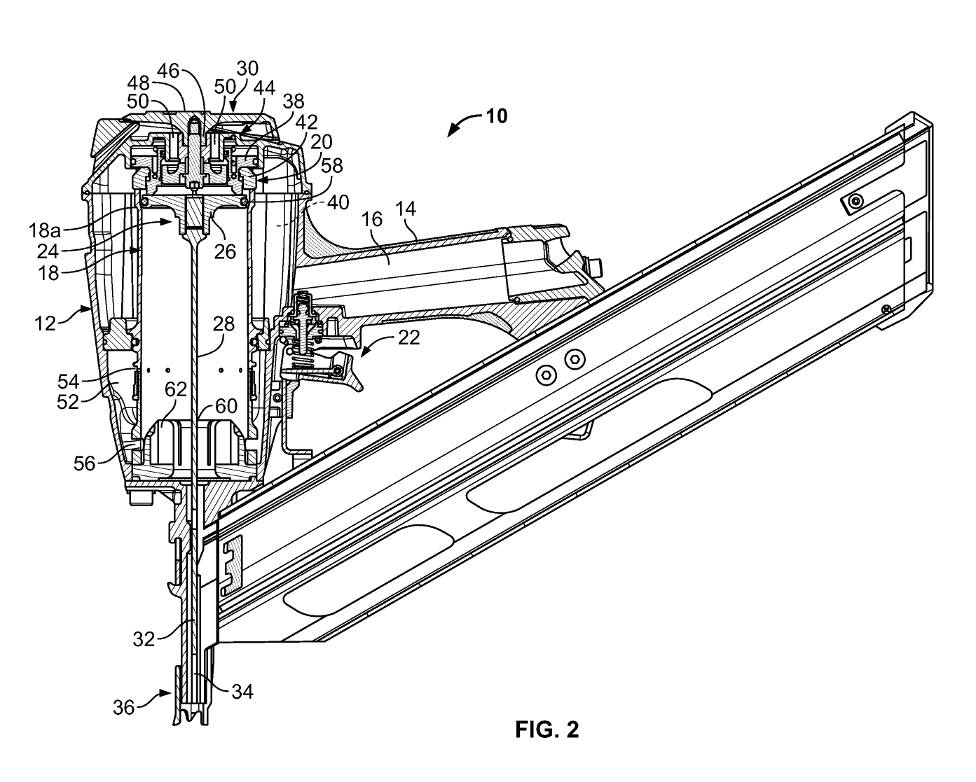

Referring now to FIGS. 1 and 2, an example of a fastener-driving tool of the present invention is illustrated where the fastener-driving tool is a pneumatic powered fastener-driving tool generally illustrated as 10. The fastener-driving tool 10 embodies a control valve assembly and bumper arrangement according to the present invention. The tool 10 may be of known construction, and, as illustrated, comprises a housing 12 including a generally vertically extending head or forward portion and a rearwardly extending hollow handle 14 having a cavity defining a fluid reservoir 16. Pressurized fluid such as compressed air is supplied to the fluid reservoir 16 of the tool by a suitable flexible line. The drive system for the tool 10 includes a main or power cylinder 18 mounted within the head portion of the housing 12 and having an open upper end 18a that is adapted to be selectively connected to the reservoir 16. The open upper end of the cylinder 18 is in engagement with a main or cylinder valve assembly 20 of a known type, under the control of a control valve assembly 22 according to the present invention. A fastener-driving assembly 24 slidably mounted in the cylinder 18 includes a main or drive piston 26 and has connected thereto a depending drive blade member 28. The fastener-driving assembly 24 is normally biased to a position with the piston 26 adjacent the cylinder valve assembly 20. An exhaust valve assembly indicated generally as 30 is provided for controlling the selective connection of the upper end of the cylinder 18 to the atmosphere.

When the tool 10 is to be operated, compressed fluid from the reservoir 16 enters the upper open end 18a of the cylinder 18 and drives the fastener-driving assembly 24 downwardly to engage and set a fastener or nail 32 supplied to a drive track 34 in a nosepiece or nosepiece structure 36. The flow of compressed fluid in the upper end of the cylinder 18 is controlled by the main valve assembly 20, which includes a vertically movable ring member 38 defining a valve element. The cylinder side of the ring member 38 is continuously in communication with the fluid reservoir 16 through a suitable passageway 40 so that pressurized fluid continuously acts against the cylinder side of the ring member 38 tending to displace the ring member 38 from the upper end or edge 18a of the cylinder 18. However pressurized fluid is also introduced to the opposite side of the ring member 38 through a passageway while the fastener-driving tool 10 is in a static or at rest position. The differential pressure acting on the ring member 38 is effective to maintain the ring member 38 down, in a closed position, with a sealing ring 42 against the upper end 18a of the cylinder 18. However if the pressurized fluid above the ring member 38 is discharged, the pressurized fluid acting through the passageway 40 is effective to unseat the ring member 38 from the upper end or edge 18a of the cylinder 18 to dump pressurized fluid into the top of the main cylinder 18 and to drive the drive piston 26 through the drive stroke.

When the fastener-driving tool 10 is at rest, or during the return stroke of the drive piston 26, the upper open end of the cylinder 18 is exhausted to the atmosphere through the exhaust valve assembly 30. In the illustrated embodiment the exhaust valve assembly 30 includes a valve member 44 spaced below an inner surface of a downwardly projecting boss 46 defined in a cap 48 of the tool 10. The cap 48 has a plurality of exhaust passageways 50 providing for the exhaust of the fluid when the ring member 38 is in its downward position.

To provide for the return stroke of the fastener-driving assembly 24, there is provided a return air chamber 52 communicating with the lower end of the cylinder 18 through a plurality of fluid inlet ports 54 and a plurality of fluid outlet ports 56. Moreover the drive piston 26 is provided with at least one O-ring 58 for sealing the drive piston relative to an inner surface of the cylinder 18.

Thus, it will be understood that in the normal operation of the fastener-driving tool 10, the working fluid above the piston 26 will flow through the fluid inlet ports 54 into the return air chamber 52, and will thereafter flow through the fluid outlet ports 56 below the piston 26 to drive the piston 26 back through its return stroke. The fluid pressure drop should be less through the port beneath the piston than above, otherwise it will not be displaced sufficiently, blocking ports 54 and allowing the full return stroke. A greater volume of fluid will exit from chamber 52 to the bottom of the driver thus shifting it upwardly and closing off flow from passage 62 to above the driver and to atmosphere. Residual return fluid below the piston 26 will be dissipated to atmosphere by bleeding through a bleed opening 60 formed between the drive blade 28 and a bumper assembly 62.

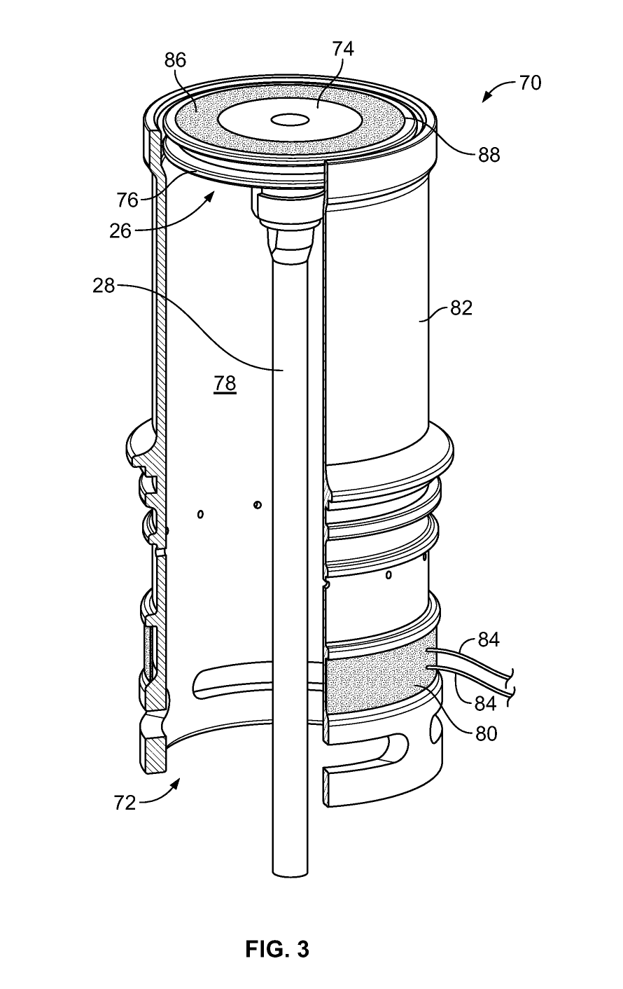

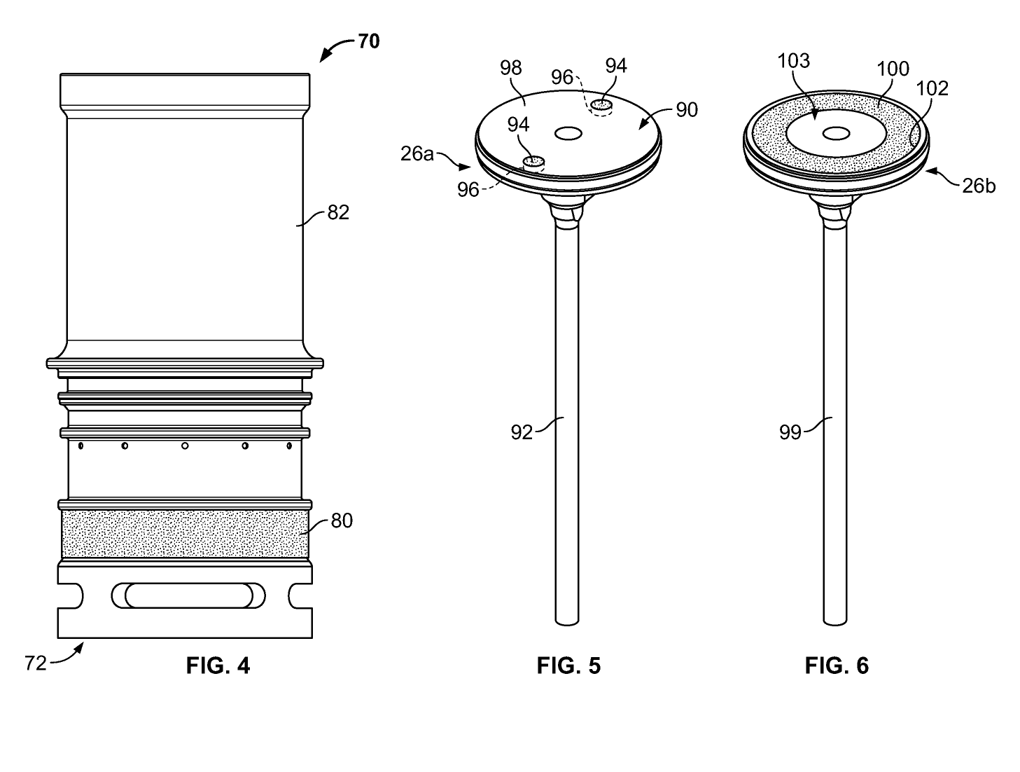

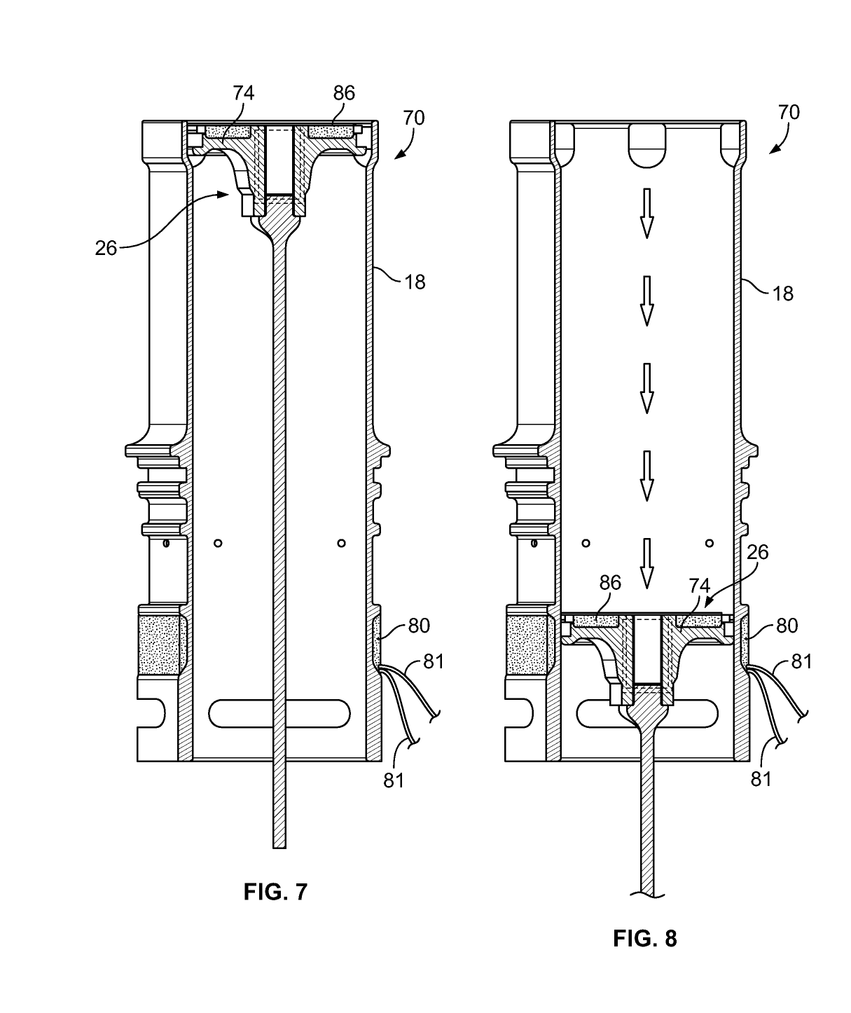

Referring now to FIGS. 3-8, an embodiment of a piston assembly employed in the above fastener-driving tool is illustrated where the piston assembly, generally indicated as 70, includes a cylinder or sleeve 18 defining a through-hole 72. As described above, a piston 26 is configured to reciprocally move within the cylinder 18 and has a circular top portion 74 and a driver blade 28 extending from the top portion for driving one or more fasteners into a workpiece. The top portion 74 of the piston 26 is configured to have a size and shape that fits within the through-hole 72 of the cylinder 18. The piston 26 is configured to move between a first position, where the top portion 74 of the piston 26 is at the top end of the cylinder and a second position, where the top portion 74 of the piston 26 is at a bottom end of the cylinder. As shown in FIGS. 7 and 8, the piston 26 moves downwardly through the through-hole 72 in the cylinder 18 so that the driver blade 28 strikes a fastener 32 for driving that fastener into a workpiece. The piston 26 then returns to the top end of the cylinder 18 to repeat this operation.

In various embodiments, one or more sensors or inductors are associated with the cylinder 18. For example, in the illustrated embodiment, the one or more sensors or inductors are located on the cylinder. In the illustrated embodiment, each inductor includes one or a plurality of coils 80 that are wound or wrapped around an outer surface or outer peripheral surface 82 of the cylinder 18 as shown in FIG. 3. The coils 80 are preferably wire coils, such as copper coils, or other suitable conductive metal coils. A pair of electrical wires or cables 84 is attached to the coils 80 for transferring electrical energy or electricity from the coils as will be further described below. The top portion 74 of the piston 26 includes at least one signal generator associated with the piston. In the illustrated embodiment, the signal generator is an annular magnet 86 seated in a corresponding annular recess 88. It should be appreciated that one or a plurality of magnets 86 may be attached to the top portion 74 of the piston 26 and may have any suitable size or shape. It should also be appreciated that the sensor or sensors may be on an inside or outside surface of the cylinder, adjacent to the cylinder or on any suitable part of the tool relative to the cylinder and the piston.

As the piston 26 moves relative to, through or past the wire coils 80, and more specifically, as the signal generator or magnet on the piston moves relative to or past the wire coils, i.e., sensors, electricity is generated by electromagnetic induction. The primary principle behind the generation of electricity in this manner is Faraday's Law. Faraday's Law is a basic law of electromagnetism and states that an induced electromotive force (EMF) in a closed circuit is equal to the time rate of change of the magnetic flux through the circuit. Thus, by attaching the magnet 86 to the piston 26 and the wire coils 80 on the cylinder 18, electrical energy is generated and can be used to power or recharge internal power sources or components of the tool such as indicators (lights, speakers, vibration devices) associated with the operation of the tool. The generated electricity or electrical energy may also be stored for subsequent use in one or more internal batteries or removable and rechargeable batteries. The present piston assembly thereby utilizes the existing moving components of a fastener-driving tool to generate additional electrical energy, which in turn, conserves electrical energy or power stored in the internal tool power sources, such as the internal batteries and the removable and rechargeable main battery.

The amount of electrical energy or electricity generated by the present piston assembly 70 depends on three factors: the number of inductors and/or winds of the coil 80 on the cylinder 18, the strength of the magnetic field generated by the magnet 86 and the speed at which the magnetic field (i.e., the magnet) moves relative to or through the coil or coils 80. Adjusting or varying any one of these factors or more than one of these factors will vary the amount of the generated electricity that can be used to power or recharge one or more the internal batteries in the tool or other power sources. For example, increasing the number of coils on the sleeve will increase the amount of electrical energy or power generated by the present piston assembly. Similarly, increasing the strength of the magnet will increase the electrical energy or power generated by the piston assembly.

FIGS. 5 and 6 show different embodiments of the piston 26. Specifically, FIG. 5 shows an embodiment of the piston 26a having a circular top portion 90 and a driver blade 92 extending from the top portion where two signal generators, such as cylindrical magnets 94, are inserted in corresponding spaced or spaced apart recesses or receptacles 96 defined by a top surface 98 of the top portion 90 of the piston 26a. The magnets 94 may have any suitable size or shape and can be circular, square and the like. Also, FIG. 5 shows a piston having two magnets 94. The piston 26a may have one, two or several magnets 94 attached to the top portion 90 of the piston 26a.

FIG. 6 shows another embodiment of the piston 26b having a driver blade 99 where the magnet 100 is a single annular ring positioned in an annular recess or receptacle 102 and attached to the top portion 103 of the piston 26b. It should be appreciated that the piston 26b may have one or a plurality of annular magnetic rings 100 where the rings are concentric and spaced a predetermined distance from each other.

Referring now to FIGS. 7 and 8, the present piston assembly 70 is illustrated where the top portion 74 of the piston 26 including the magnet 86 begins at a first position at the top of the cylinder 18 and moves to a second position at the bottom of the cylinder where the magnet passes the inductors including metal coils 80 thereby generating electricity that is transferred to one or more internal power sources of the tool by suitable wires or cables 81. As stated above, the amount of electricity generated by the present piston assembly depends on the number of coils 80 on the cylinder 18, the strength and/or the number of magnets 86 on the piston 26, and the speed at which the magnet on the top portion of the piston moves relative to the coils.

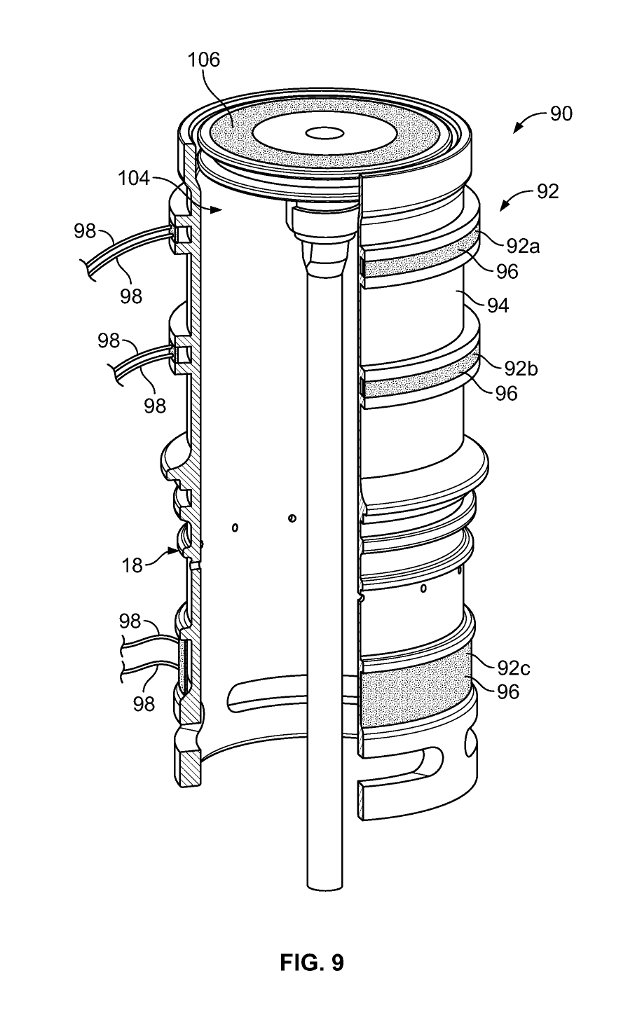

Referring now to FIG. 9, another embodiment of the piston assembly 90 is illustrated where a plurality of magnetic coil sections 92 on an outer surface 94 of the cylinder 18 each include one or more magnetic coils 96. Specifically, the cylinder 18 includes a first inductor or coil section 92a, a second inductor or coil section 92b and a third inductor or coil section 92c. Each of the first, second and third coil sections 92a, 92b, 92c have two wires or cables 98 connected to the coils 96 in the coil sections 92a, 92b and 92c for providing power to and transmitting power from the coils to other components of the tool. Similar to the piston 100 assembly described above, the piston 104 includes an annular magnet 106 that generates electricity as it passes by each of the first, second and third coil sections 92a, 92b and 92c. The piston assembly 100 thereby generates more electricity than the above embodiment because there are more coils attached to the cylinder 18. It should be appreciated that the cylinder may have one or a plurality of coil sections 92 each including one or more coils 96, and preferably metal coils, for creating electromagnetic induction.

The above embodiments are directed to pneumatic fastening tools or pneumatic-powered fastener tools such as pneumatic nailers. It should be appreciated that the present piston assembly may be used in combustion-powered fastener-driving tools and other suitable fastening tools.

While a particular embodiment of a pneumatic-powered fastener-driving tool has been described herein, it will be appreciated by those skilled in the art that changes and modifications may be made thereto without departing from the invention in its broader aspects and as set forth in the following claims.

What is claimed is:

1. A fastener driving tool comprising:
a housing;
a cylinder enclosed by said housing;
at least one sensor associated with said cylinder;
a piston configured to reciprocate within said cylinder and having a driver blade depending therefrom; and
at least one signal generator associated with said piston, wherein movement of said piston relative to said at least one sensor generates a signal.

2. The tool of claim 1, wherein said at least one signal generator includes a magnet and said at least one sensor includes an inductor.

3. The tool of claim 2, wherein said inductor includes at least one wire coil.

4. The tool of claim 1, wherein said at least one signal generator includes a plurality of magnets and said at least one sensor includes a plurality of inductors.

5. The tool of claim 4, wherein each of said plurality of inductors includes at least one wire coil.

6. The tool of claim 1, wherein said at least one sensor includes a wire coil.

7. The tool of claim 1, wherein said at least one sensor includes a plurality of wire coils.

8. The tool of claim 1, wherein said cylinder includes an outer peripheral surface and said at least one sensor is on said outer peripheral surface.

9. The tool of claim 1, wherein said at least one signal generator includes at least one annular magnet attached to said piston.

10. The tool of claim 1, further comprising a plurality of magnets attached to said piston.

11. The tool of claim 10, wherein said plurality of magnets includes cylindrical magnets spaced apart on said piston.

12. The tool of claim 1, further comprising at least one power storage device in communication with said at least one sensor for storing the electricity.

13. The tool of claim 12, wherein said at least one power storage device includes at least one battery.

14. A fastener-driving tool comprising:
a housing;
a cylinder enclosed by said housing;
a plurality of sensors associated with said cylinder;
a piston configured to reciprocate within said cylinder and having a driver blade depending therefrom;
at least one signal generator associated with said piston, wherein movement of said piston relative to each of said plurality of sensors generates electricity; and
a storage device configured to receive and store the electricity.

15. The tool of claim 14, wherein said plurality of sensors each include at least one wire coil.

16. The tool of claim 14, wherein said plurality of sensors each includes a plurality of wire coils.

17. The tool of claim 14, further comprising a plurality of magnets attached to said piston.

18. The tool of claim 17, wherein said plurality of magnets includes cylindrical magnets spaced apart on said piston.

19. The tool of claim 14, wherein said at least one power storage device includes at least one battery.
